(19) United States
(12) Patent Application Publication
(10) Pub. No.: US 2019/0370982 A1
(43) Pub. Date: Dec. 5, 2019

(54) MOVEMENT LEARNING DEVICE, SKILL DISCRIMINATING DEVICE, AND SKILL DISCRIMINATING SYSTEM

(71) Applicant: Mitsubishi Electric Corporation, Tokyo (JP)

(72) Inventor: Ryosuke SASAKI, Tokyo (JP)

(73) Assignee: Mitsubishi Electric Corporation, Tokyo (JP)

(21) Appl. No.: 16/475,230

(22) PCT Filed: Feb. 24, 2017
(86) PCT No.: PCT/JP2017/007104

§ 371 Date: Jul. 1, 2019

(51) Int. Cl. G06T 7/246; G06T 7/00; G06F 3/14

(52) U.S. Cl. CPC G06T 7/248; G06T 7/0002; G06F 3/14; G06T 2207/10016; G06T 2207/20072; G06T 2207/20081; G06T 2207/30196

(57) ABSTRACT

This movement learning device is provided with: a first movement characteristic extracting unit (102) for extracting locus characteristics of movement of skilled workers and ordinary workers, on the basis of moving image data obtained by capturing images of the skilled workers and the ordinary workers; a movement characteristic learning unit (103) for clustering the locus characteristics that are similar to reference locus characteristics determined from among the extracted locus characteristics, generating a histogram on the basis of frequencies of occurrence of the clustered locus characteristics, and performing discrimination learning for identifying locus characteristics of skilled movement on the basis of the generated histogram; and a discrimination function generating unit (104) for referring to the discrimination learning results, and generating a discrimination function indicating a boundary for discriminating between skilled and unskilled movements.

### TECHNICAL FIELD

The present invention relates to a technology for evaluating movement of an evaluation target person on the basis of moving image data.

### BACKGROUND ART

In order to enhance work efficiencies of workers who are working in a factory or the like, a mechanism for extracting skills of skilled workers (hereinafter referred to as “skilled worker”), and for transferring the skills to ordinary workers (hereinafter referred to as “ordinary worker”) who are not skilled workers, is required. Specifically, a movement that differs from movements of ordinary workers is detected from among movements of skilled workers, and the detected movement is shown to the ordinary workers, thereby supporting an improvement in skills of the ordinary workers.

For example, a movement characteristic extracting device disclosed in patent document 1 takes an image of a figure of a skilled worker who engages in a certain working process, and takes an image of a figure of an ordinary worker when the ordinary worker engages in the same working process at the same image taking angle, and consequently abnormal movement performed by the ordinary worker is extracted. In more detail, Cubic Higher-order Local Auto-Correlation (CHLAC) characteristics are extracted from moving image data of the skilled worker, CHLAC characteristics are extracted from an evaluation target image of the ordinary worker, and abnormal movement of the ordinary worker is extracted on the basis of correlation of the extracted CHLAC characteristics.

### CITATION LIST

### Patent Literatures

Patent Literature 1: Japanese Unexamined Patent Application Publication No. 2011-133984

### SUMMARY OF INVENTION

### Technical Problem

However, in the technology disclosed in the above-described patent document 1, with respect to the movement characteristics in the moving image data, it is necessary to prepare a plurality of fixed mask patterns of CHLAC characteristics. Therefore, there arises a problem that it is necessary for users to design mask patterns for movements of skilled workers.

The present invention has been made to solve such a problem as described above, and an object of the present invention is to obtain an indicator for discriminating skills of an evaluation target worker on the basis of movements of skilled workers extracted from moving image data without designing mask patterns for the movements of the skilled workers.

### Solution to Problem

The movement learning device of the invention according to the present invention is provided with: a first movement characteristic extracting unit for extracting locus characteristics of movement of skilled workers and ordinary workers, on the basis of moving image data obtained by capturing images of the skilled workers and the ordinary workers; a movement characteristic learning unit for clustering the locus characteristics that are similar to reference locus characteristics determined from among the locus characteristics extracted by the first movement characteristic extracting unit, generating at least one histogram on the basis of frequencies of occurrence of the clustered locus characteristics, and performing discrimination learning for identifying locus characteristics of skilled movement on the basis of the generated histogram; and a discrimination function generating unit for referring to a result of the discrimination learning by the movement characteristic learning unit, and generating a discrimination function indicating a boundary for discriminating between skilled and unskilled movements.

### Advantageous Effects of Invention

According to the present invention, skilled movements of skilled workers can be extracted from moving image data, and an indicator for discriminating skills of an evaluation target worker can be obtained on the basis of the extracted movements.

### BRIEF DESCRIPTION OF DRAWINGS

FIG. 1 is a block diagram illustrating a configuration of a skill discriminating system according to a first embodiment.

FIGS. 2A and 2B are diagrams each illustrating a hardware configuration of a movement learning device according to the first embodiment.

FIGS. 3A and 3B are diagrams each illustrating an example of a hardware configuration of a skill discriminating device according to the first embodiment.

FIG. 4 is a flowchart illustrating operation of the movement learning device according to the first embodiment.

FIG. 5 is a flowchart illustrating operation of the skill discriminating device according to the first embodiment.

FIGS. 6A, 6B, 6C and 6D are explanatory drawings each illustrating processing of the movement learning device according to the first embodiment.

FIG. 7 is a drawing illustrating a display example of discrimination result from the skill discriminating device according to the first embodiment.

FIG. 8 is a block diagram illustrating a configuration of a skill discriminating system according to a second embodiment.

FIG. 9 is a flowchart illustrating operation of a movement learning device according to the second embodiment.

FIG. 10 is a flowchart illustrating operation of a skill discriminating device according to the second embodiment.

FIG. 11 is a drawing illustrating effects produced in a case where a sparse regularization term is added in the movement learning device according to the first embodiment.

### DESCRIPTION OF EMBODIMENTS

In order to describe the present invention in further detail, embodiments for carrying out the present invention will be described below with reference to the accompanying drawings.

### First Embodiment

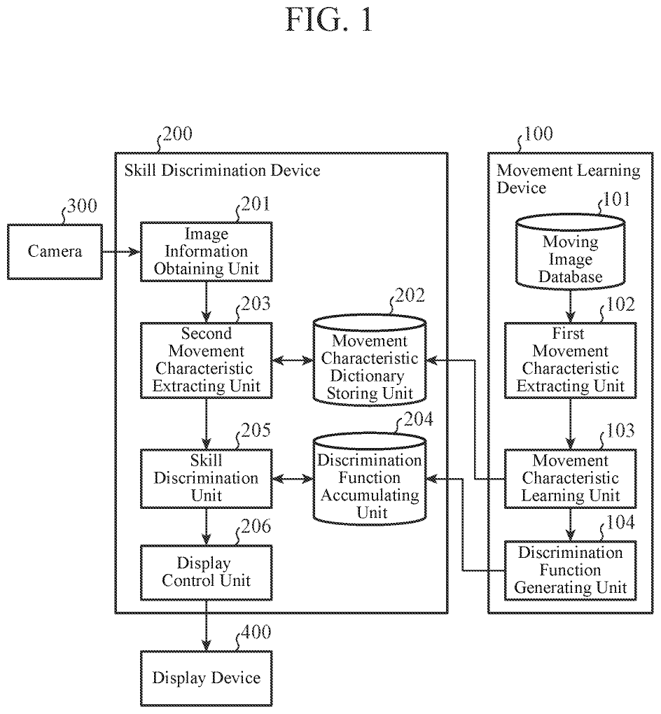

FIG. 1 is a block diagram illustrating a configuration of a skill discriminating system according to the first embodiment.

The skill discriminating system includes a movement learning device 100, and a skill discriminating device 200. The movement learning device 100 analyzes difference in characteristics of movement between a skilled worker (hereinafter referred to as “skilled worker”) and an ordinary worker who is not a skilled worker (hereinafter referred to as “ordinary worker”), and generates a function used to discriminate skills of an evaluation target worker. Here, it is assumed that evaluation target workers include a skilled worker and an ordinary worker. The skill discriminating device 200 uses the function generated by the movement learning device 100 to discriminate whether or not skills of an evaluation target worker are proficient.

The movement learning device 100 is provided with a moving image database 101, a first movement characteristic extracting unit 102, a movement characteristic learning unit 103, and a discrimination function generating unit 104.

The moving image database 101 is a database that stores moving image data obtained by capturing images of work states of a plurality of skilled workers and a plurality of ordinary workers. The first movement characteristic extracting unit 102 extracts locus characteristics of movement of skilled workers and ordinary workers from the moving image data stored in the moving image database 101. The first movement characteristic extracting unit 102 outputs the extracted locus characteristics of movement to the movement characteristic learning unit 103.

The movement characteristic learning unit 103 determines reference locus characteristics of movement from the locus characteristics of movement extracted by the first movement characteristic extracting unit 102. The movement characteristic learning unit 103 performs discrimination learning for identifying locus characteristics of skilled movement on the basis of the reference locus characteristics of movement. The movement characteristic learning unit 103 generates a movement characteristic dictionary that describes the determined reference locus characteristics of movement, and stores the movement characteristic dictionary in a movement characteristic dictionary storing unit 202 of the skill discriminating device 200. In addition, the movement characteristic learning unit 103 outputs a result of discrimination learning to the discrimination function generating unit 104. The discrimination function generating unit 104 refers to the result of learning by the movement characteristic learning unit 103, and generates a function used to discriminate whether or not skills of an evaluation target worker are proficient (hereinafter referred to as “discrimination function”). The discrimination function generating unit 104 accumulates the generated discrimination function in a discrimination function accumulating unit 204 of the skill discriminating device 200.

The skill discriminating device 200 includes an image information obtaining unit 201, a movement characteristic dictionary storing unit 202, a second movement characteristic extracting unit 203, the discrimination function accumulating unit 204, and a skill discriminating unit 205, and a display control unit 206. In addition, a camera 300 that captures an image of work of an evaluation target worker, and a display device 400 that displays information on the basis of display control by the skill discriminating device 200 are connected to the skill discriminating device 200.

The image information obtaining unit 201 obtains moving image data obtained when the camera 300 captures an image of a work state of the evaluation target worker (hereinafter referred to as “evaluation-target moving image data”). The image information obtaining unit 201 outputs the obtained moving image data to the second movement characteristic extracting unit 203. The movement characteristic dictionary storing unit 202 stores the movement characteristic dictionary that describes the reference locus characteristics of movement input from the movement learning device 100.

The second movement characteristic extracting unit 203 refers to the movement characteristic dictionary stored in the movement characteristic dictionary storing unit 202, and extracts locus characteristics of movement from the evaluation-target moving image data obtained by the image information obtaining unit 201. The second movement characteristic extracting unit 203 outputs the extracted locus characteristics of movement to the skill discriminating unit 205. The discrimination function accumulating unit 204 is an area in which the discrimination function generated by the discrimination function generating unit 104 of the movement learning device 100 is accumulated. The skill discriminating unit 205 uses the discrimination function accumulated in the discrimination function accumulating unit 204 to discriminate, from the locus characteristics of movement extracted by the second movement characteristic extracting unit 203, whether or not skills of an evaluation target worker are proficient. The skill discriminating unit 205 outputs the discrimination result to the display control unit 206. In accordance with the discrimination result from the skill discriminating unit 205, the display control unit 206 determines information to be displayed as support information for the evaluation target worker. The display control unit 206 performs the display control that causes the display device 400 to display the determined information.

Next, hardware configurations of the movement learning device 100 and the skill discriminating device 200 will be described as examples.

First of all, an example of a hardware configuration of the movement learning device 100 will be described.

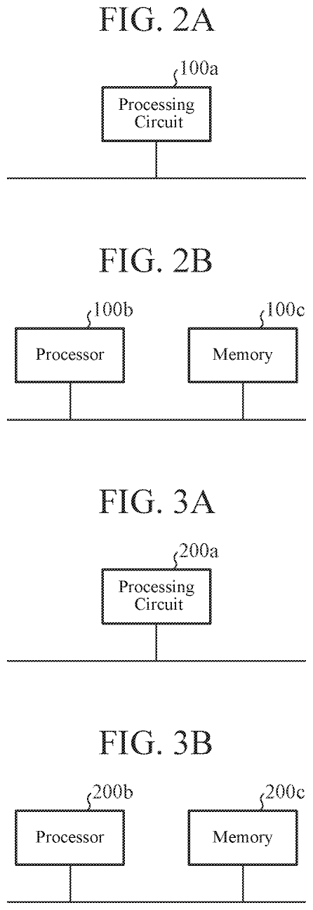

FIGS. 2A and 2B are diagrams each illustrating an example of a hardware configuration of the movement learning device 100 according to the first embodiment.

Functions of the first movement characteristic extracting unit 102, the movement characteristic learning unit 103 and the discrimination function generating unit 104 in the movement learning device 100 are implemented by a processing circuit. In other words, the movement learning device 100 is provided with the processing circuit for implementing the functions described above. The processing circuit may be a processing circuit 100a that is dedicated hardware as shown in FIG. 2A, or may be a processor 100b that executes a program stored in a memory 100c as shown in FIG. 2B.

As shown in FIG. 2A, in a case where the first movement characteristic extracting unit 102, the movement characteristic learning unit 103 and the discrimination function generating unit 104 are implemented by the dedicated hardware, the processing circuit 100a corresponds to, for example, a single circuit, a composite circuit, a programmed processor, a parallel-programmed processor, an Application Specific Integrated Circuit (ASIC), a Field-programmable Gate Array (FPGA), or a combination thereof. Each of the functions of the first movement characteristic extracting unit 102, the movement characteristic learning unit 103 and the discrimination function generating unit 104 may be implemented by a processing circuit, or the functions may be collectively implemented by one processing circuit.

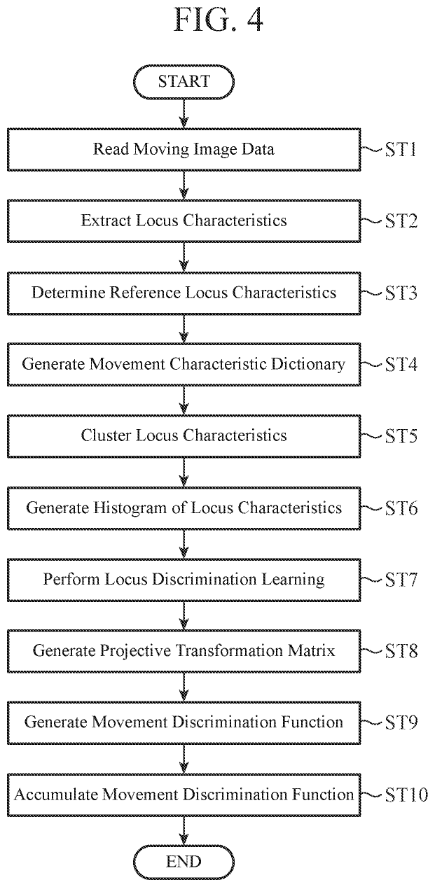

As shown in FIG. 2B, in a case where the first movement characteristic extracting unit 102, the movement characteristic learning unit 103 and the discrimination function generating unit 104 are implemented by the processor 100b, the functions of the units are implemented by software, firmware, or a combination of software and firmware. Software or firmware is described as a program, and is stored in the memory 100c. By reading programs stored in the memory 100c, and then by executing the programs, the processor 100b implements the functions of the first movement characteristic extracting unit 102, the movement characteristic learning unit 103 and the discrimination function generating unit 104. In other words, the movement characteristic extracting unit, the movement characteristic learning unit 103 and the discrimination function generating unit 104 are provided with the memory 100c for storing a program; when the program is executed by the processor 100b, each step shown in FIG. 4 described later is consequently executed. In addition, it can also be said that these programs cause a computer to execute steps or methods of the first movement characteristic extracting unit 102, the movement characteristic learning unit 103 and the discrimination function generating unit 104.

Here, the processor 100b is, for example, a Central Processing Unit (CPU), a processing unit, a computation device, a processor, a microprocessor, a microcomputer, a Digital Signal Processor (DSP) or the like.

The memory 100c may be, for example, a non-volatile or volatile semiconductor memory such as a Random Access Memory (RAM), a Read Only Memory (ROM), a flash memory, an Erasable Programmable ROM (EPROM) or an Electrically EPROM (EEPROM), may be a magnetic disk such as a hard disk or a flexible disk, or may be an optical disk such as a MiniDisk, a Compact Disc (CD) or a Digital Versatile Disc (DVD).

It should be noted that with respect to the functions of the first movement characteristic extracting unit 102, the movement characteristic learning unit 103 and the discrimination function generating unit 104, some of them may be implemented by dedicated hardware, and some of them may be implemented by software or firmware. In this manner, the processing circuit 100a in the movement learning device 100 is capable of implementing the above-described functions by hardware, software, firmware, or a combination thereof.

Next, an example of a hardware configuration of the skill discriminating device 200 will be described.

FIGS. 3A and 3B are diagrams each illustrating an example of a hardware configuration of the skill discriminating device 200 according to the first embodiment.

Functions of the image information obtaining unit 201, the second movement characteristic extracting unit 203, the skill discriminating unit 205 and the display control unit 206 in the skill discriminating device 200 are implemented by a processing circuit. In other words, the skill discriminating device 200 is provided with the processing circuit for implementing the functions described above. The processing circuit may be a processing circuit 200a that is dedicated hardware as shown in FIG. 3A, or may be a processor 200b that executes a program stored in a memory 200c as shown in FIG. 3B.

As shown in FIG. 3A, in a case where the image information obtaining unit 201, the second movement characteristic extracting unit 203, the skill discriminating unit 205 and the display control unit 206 are implemented by the dedicated hardware, the processing circuit 200a corresponds to, for example, a single circuit, a composite circuit, a programmed processor, a parallel-programmed processor, ASIC, FPGA, or a combination thereof. Each of the functions of the image information obtaining unit 201, the second movement characteristic extracting unit 203, the skill discriminating unit 205 and the display control unit 206 may be implemented by a processing circuit, or the functions may be collectively implemented by one processing circuit.

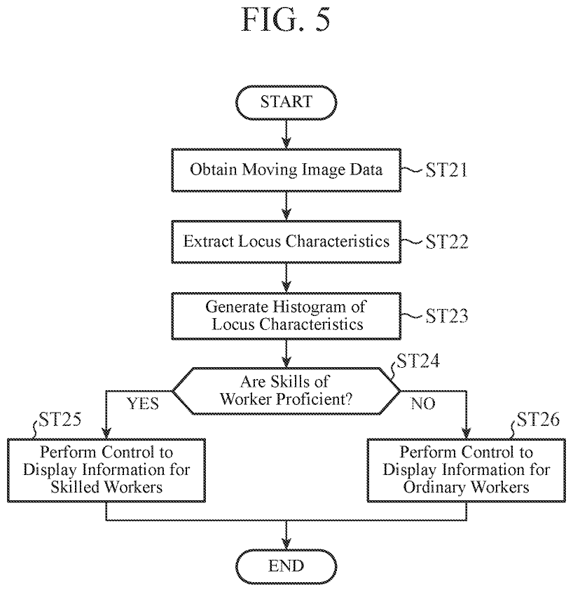

As shown in FIG. 3B, in a case where the image information obtaining unit 201, the second movement characteristic extracting unit 203, the skill discriminating unit 205 and the display control unit 206 are implemented by the processor 200b, the functions of the units are implemented by software, firmware, or a combination of software and firmware. Software or firmware is described as a program, and is stored in the memory 200c. By reading programs stored in the memory 200c, and then by executing the programs, the processor 200b implements the functions of the image information obtaining unit 201, the second movement characteristic extracting unit 203, the skill discriminating unit 205 and the display control unit 206. In other words, the image information obtaining unit 201, the second movement characteristic extracting unit 203, the skill discriminating unit 205 and the display control unit 206 are provided with the memory 200c for storing a program; when the program is executed by the processor 200b, each step shown in FIG. 5 described later is consequently executed. In addition, it can also be said that these programs cause a computer to execute steps or methods of the image information obtaining unit 201, the second movement characteristic extracting unit 203, the skill discriminating unit 205 and the display control unit 206.

It should be noted that with respect to the respective functions of the image information obtaining unit 201, the second movement characteristic extracting unit 203, the skill discriminating unit 205 and the display control unit 206, some of them may be implemented by dedicated hardware, and some of them may be implemented by software or firmware. In this manner, the processing circuit 200a in the skill discriminating device 200 is capable of implementing the above-described functions by hardware, software, firmware, or a combination thereof.

Next, the operation of the movement learning device 100 and the operation of the skill discriminating device 200 will be described. First of all, the operation of the movement learning device 100 will be described.

FIG. 4 is a flowchart illustrating the operation of the movement learning device 100 according to the first embodiment.

The first movement characteristic extracting unit 102 reads, from the moving image database 101, moving image data obtained by capturing images of movements of skilled workers and ordinary workers (step ST1). The first movement characteristic extracting unit 102 extracts locus characteristics of movement from the moving image data read in the step ST1 (step ST2). The first movement characteristic extracting unit 102 outputs the extracted locus characteristics to the movement characteristic learning unit 103.

The processing of the above-described step ST2 will be described in detail.

The first movement characteristic extracting unit 102 tracks characteristic points in moving image data, and extracts, as locus characteristics, change in coordinates of characteristic points over frames, the number of the frames being equal to or more than a certain fixed value. Further, in addition to the change in coordinates, the first movement characteristic extracting unit 102 may additionally extract at least one of information of an edge surrounding the characteristic point in the moving image data, a histogram of optical flows, and a histogram of primary differentiation of the optical flows. In this case, the first movement characteristic extracting unit 102 extracts, as locus characteristics, numerical information into which information obtained in addition to the change in coordinates is integrated.

From among locus characteristics extracted in the step ST2, the movement characteristic learning unit 103 determines a plurality of reference locus characteristics (step ST3). By using the plurality of reference locus characteristics determined in the step ST3, the movement characteristic learning unit 103 creates a movement characteristic dictionary, and stores the movement characteristic dictionary in the movement characteristic dictionary storing unit 202 of the skill discriminating device 200 (step ST4).

When the movement characteristic dictionary is created in the step ST4, a clustering technique such as k-means algorithm enables to apply a method in which a median of each cluster is used as a reference locus characteristic.

By using the reference locus characteristics determined in the step ST3, the movement characteristic learning unit 103 clusters the locus characteristics extracted in the step ST2 into groups each having similar locus characteristics (step ST5).

In the processing of the step ST5, first of all, the movement characteristic learning unit 103 vectorizes the locus characteristics extracted in the step ST2. Next, on the basis of a distance between a vector of each locus characteristic and a vector of the reference locus characteristic determined in the step ST3, the movement characteristic learning unit 103 determines whether or not each locus characteristic is similar to the reference locus characteristic. The movement characteristic learning unit 103 clusters each locus characteristic on the basis of the result of the similarity determination.

On the basis of the result of clustering in the step ST5, the movement characteristic learning unit 103 generates a histogram corresponding to frequencies of occurrence of similar locus characteristics (step ST6). In the processing of the step ST6, for a skilled worker group and an ordinary worker group, respective histograms are generated. On the basis of the histograms generated in the step ST6, the movement characteristic learning unit 103 performs discrimination learning for identifying locus characteristics of skilled movement (step ST7). On the basis of the learning result of the discrimination learning in the step ST7, the movement characteristic learning unit 103 generates a projective transformation matrix for an axis corresponding to a proficiency degree of a worker (step ST8). The movement characteristic learning unit 103 outputs the projective transformation matrix generated in the step ST8 to the discrimination function generating unit 104.

On the basis of the projective transformation matrix generated in the step ST8, the discrimination function generating unit 104 generates a discrimination function indicating a boundary for identifying whether or not movement of an evaluation target worker is skilled movement (step ST9). Specifically, in the step ST9, the discrimination function generating unit 104 designs a linear discrimination function for discriminating between skilled movement and ordinary movement in the axis transformed by the projective transformation matrix. The discrimination function generating unit 104 accumulates the discrimination function generated in the step ST9 in the discrimination function accumulating unit 204 of the skill discriminating device 200 (step ST10), and the processing ends. If the discrimination function which is the linear discrimination function and accumulated in the step ST10, is equal to or more than “0”, it is indicated that the movement of the evaluation target worker is skilled movement. If the discrimination function is less than “0”, it is indicated that the movement of the evaluation target worker is ordinary movement that is not skilled.

The processing of the above-described steps ST7 and ST8 will be described in detail.

The movement characteristic learning unit 103 performs discrimination analysis by using the histograms generated in the step ST6, calculates a projection axis along which inter-class dispersion between a skilled worker group and an ordinary worker group becomes maximum, and at the same time each intra-class dispersion becomes minimum, and determines a discrimination boundary. Computation by the movement characteristic learning unit 103 maximizes Fischer's evaluation criteria indicated by following equation (1).

Jₛ(A)=A^{t}S_{B}A/A^{t}S_{W}A (1)

In the equation (1), S_{B} represents inter-class dispersion, and S_{W} represents intra-class dispersion. In addition, in the equation (1), A is a matrix for converting a histogram into one-dimensional numerical values, and is the above-described projective transformation matrix.

Lagrange undetermined multiplier method changes A that maximizes J_{S}(A) of the equation (1) to a problem of determining an extreme value in the following equation (2).

Jₛ(A)=A^{t}S_{B}A−λ(A^{t}S_{B}A−1) (2)

In the equation (2), I represents an identity matrix. When the equation (2) is expanded by partial differentiation, (S_{W}⁻¹S_{B}−λ1)A=0 is obtained, and therefore A can be determined as an eigenvector corresponding to the maximum eigenvalue of S_{W}⁻¹S_{B}. The determined eigenvector can be treated as a projective transformation matrix.

In addition, in this case, an axis along which dispersion of data is large is calculated beforehand by using principal component analysis, and subsequently discrimination analysis, or a discriminator such as a Support Vector Machine (SVM), may be used after processing of converting the axis into principal components is performed for dimensionality reduction. This enables the movement characteristic learning unit 103 to detect an axis along which dispersion between a skilled worker group and an ordinary worker group becomes maximum, and to obtain a locus that is useful for discriminating between skilled movement and ordinary movement. In other words, the movement characteristic learning unit 103 is capable of identifying a locus indicating skilled movement, and is capable of visualizing the locus.

In this manner, as the result of histogram discrimination analysis, the movement characteristic learning unit 103 performs singular value decomposition that uses, as an eigenvector, an axis along which dispersion between a skilled worker group and an ordinary worker group becomes maximum, and calculates a projective transformation matrix corresponding to the eigenvector. The movement characteristic learning unit 103 outputs the calculated projective transformation matrix to the discrimination function generating unit 104 as a proficiency component transformation matrix.

Next, the operation of the skill discriminating device 200 will be described.

FIG. 5 is a flowchart illustrating the operation of the skill discriminating device 200 according to the first embodiment.

When the image information obtaining unit 201 obtains moving image data obtained by capturing an image of a work state of an evaluation target worker (step ST21), the second movement characteristic extracting unit 203 extracts locus characteristics of movement from the moving image data obtained in the step ST21 (step ST22). The second movement characteristic extracting unit 203 refers to the movement characteristic dictionary stored in the movement characteristic dictionary storing unit 202, clusters the extracted locus characteristics, and generates a histogram corresponding to the frequencies of occurrence of the locus characteristics (step ST23). The second movement characteristic extracting unit 203 outputs the histogram generated in the step ST23 to the skill discriminating unit 205.

By using the discrimination function accumulated in the discrimination function accumulating unit 204, the skill discriminating unit 205 discriminates, from the histogram generated in the step ST23, whether or not skills of the evaluation target worker are proficient (step ST24). The skill discriminating unit 205 outputs the discrimination result to the display control unit 206. In a case where the skills of the evaluation target worker are proficient (step ST24: YES), the display control unit 206 performs the display control of the display device 400 so as to display information for skilled workers (step ST25). Meanwhile, in a case where the skills of the evaluation target worker are not proficient (step ST24: NO), the display control unit 206 performs the display control of the display device 400 so as to display information for ordinary workers (step ST26). Subsequently, the processing ends.

As described above, the discrimination function accumulated in the discrimination function accumulating unit 204 discriminates skills of the worker on the basis of whether the discrimination function is equal to or more than “0”, or is less than “0”. Accordingly, in the discrimination processing of the step ST24, if the discrimination function is equal to or more than “0”, the skill discriminating unit 205 discriminates that the skills of the worker are proficient, and if the discrimination function is less than “0”, the skill discriminating unit 205 discriminates that the skills of the worker are not proficient.

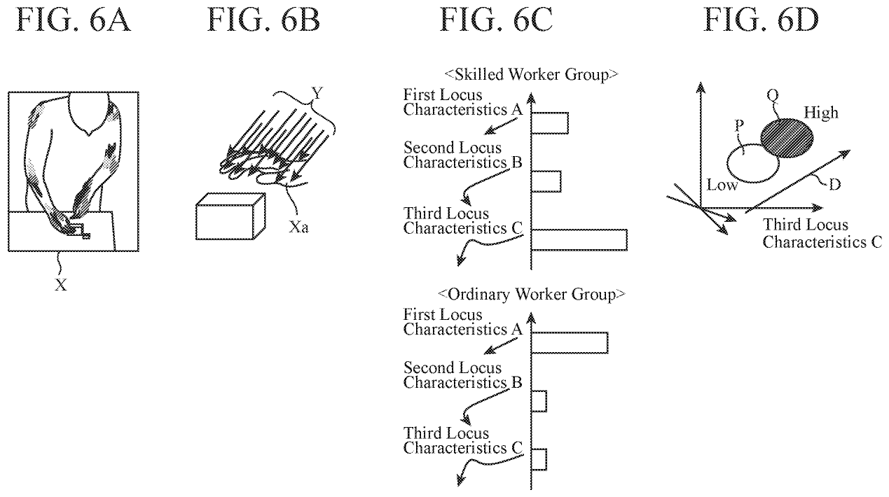

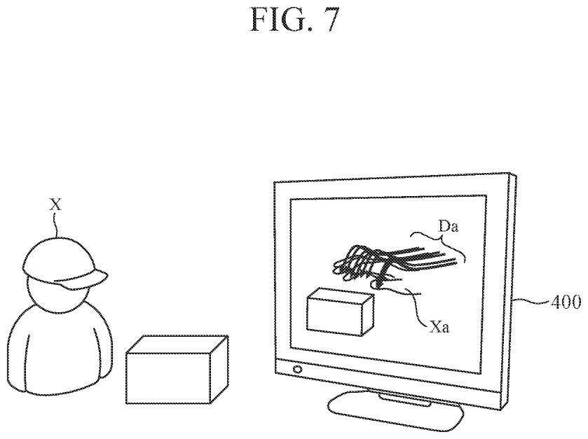

Next, effects of learning by the movement learning device 100 will be described with reference to FIGS. 6 and 7.

FIG. 6 is an explanatory drawing illustrating processing of the movement learning device 100 according to the first embodiment.

FIG. 6A is a drawing illustrating moving image data read by the first movement characteristic extracting unit 102, and uses moving image data of a worker X as an example.

FIG. 6B is a drawing illustrating locus characteristics of movement extracted from the moving image data of FIG. 6A by the first movement characteristic extracting unit 102. In the example of FIG. 6B, locus characteristics of movement Y of a hand Xa of the worker X are illustrated.

FIG. 6C is a drawing illustrating results of learning the locus characteristics Y of FIG. 6B by the movement characteristic learning unit 103. As shown in FIG. 6C, a case where the movement characteristic learning unit 103 determines, from the locus characteristics Y, three reference locus characteristics, that is to say, the first locus characteristics A, the second locus characteristics B, and the third locus characteristics C, is shown. In addition, the result of generating a histogram by clustering the locus characteristics Y shown in FIG. 6B into the first locus characteristics A, the second locus characteristics B and the third locus characteristics C is shown. Since the movement characteristic learning unit 103 generates a histogram for skilled workers and a histogram for ordinary workers, a histogram for a skilled worker group and a histogram for an ordinary worker group are generated as shown in FIG. 6C. In the histogram of the skilled worker group shown in FIG. 6C, the third locus characteristics C are the highest. Meanwhile, in the histogram of the ordinary worker group, the first locus characteristics A are the highest.

FIG. 6D shows a case where a locus D indicating skilled movement identified by the movement characteristic learning unit 103 is visualized and displayed in a space (hereinafter referred to as “work skill space”) indicating skills of work. The horizontal axis shown in FIG. 6D indicates the third locus characteristics C, and each of the other axes represents the frequency of occurrence of corresponding locus characteristics. The example of FIG. 6D indicates that a skill level increases with the progress in an arrow direction of the locus D, and the skill level decreases with the progress in an anti-arrow direction of the locus D. By converting the locus characteristics of skilled workers and ordinary workers into histograms, a work skill space is generated, and movements identified by the movement characteristic learning unit 103 can be mapped therein. This enables to assume that movements of a skilled worker and an ordinary worker are distributed in respective different regions in the work skill space. Paying attention only to inter-class dispersion between a region P in which a skill level is low and a region Q in which a skill level is high shown in FIG. 6D, first of all, the movement characteristic learning unit 103 learns a boundary thereof. The movement characteristic learning unit 103 determines a straight line orthogonal to the learned boundary as an axis of the skilled locus.

The display control unit 206 of the skill discriminating device 200 may perform the control in such a manner that a degree of the skill level of the evaluation target worker is displayed on the basis of the discrimination result from the skill discriminating unit 205 by using the work skill space shown in FIG. 6D.

FIG. 7 is a drawing illustrating an example of a case where the discrimination result from the skill discriminating device 200 according to the first embodiment is displayed on the display device 400.

In the example shown in FIG. 7, it is discriminated that skills of the worker X are not proficient, and thus a locus Da of skilled movement is displayed for the worker X through the display device 400. By visually recognizing the display, the worker X is capable of easily recognizing a point to be improved by the worker X.

As described above, according to the first embodiment, the movement learning device is configured to be provided with: the first movement characteristic extracting unit 102 that extracts locus characteristics of movement of skilled workers and ordinary workers on the basis of moving image data obtained by capturing images of the skilled workers and the ordinary workers; the movement characteristic learning unit 103 that clusters locus characteristics that are similar to reference locus characteristics determined from among the extracted locus characteristics, generates at least one histogram on the basis of the frequencies of occurrence of the clustered locus characteristics, and performs discrimination learning for identifying locus characteristics of skilled movement on the basis of the generated histogram; and the discrimination function generating unit 104 that refers to a result of the discrimination learning, and generates a discrimination function indicating a boundary for discriminating between skilled and unskilled movements. Therefore, skilled movements of the skilled workers can be extracted from the moving image data, and an indicator for discriminating skills of the evaluation target worker can be obtained from the extracted movements.

In addition, according to the first embodiment, the skill discriminating device is configured to be provided with: the second movement characteristic extracting unit 203 that extracts, from moving image data obtained by capturing an image of work of an evaluation target worker, locus characteristics of movement of the evaluation target worker, clusters the extracted locus characteristics by using reference locus characteristics determined beforehand, and generates a histogram on the basis of frequencies of occurrence of the clustered locus characteristics; the skill discriminating unit 205 that discriminates, from the generated histogram, whether or not a movement of the evaluation target worker is proficient, by using a predetermined discrimination function for discriminating skilled movement; and the display control unit 206 that performs the control to display information for skilled workers in a case where the movement of the evaluation target worker is proficient, and performs the control to display information for unskilled workers in a case where the movement of the evaluation target worker is not proficient, on the basis of a result of the discrimination. Therefore, from the moving image data obtained by capturing an image of work of the evaluation target worker, skills of the worker can be discriminated. Information to be presented can be switched in accordance with the discrimination result, and skills can be transferred to ordinary workers while preventing work of a skilled worker from being hindered, or while preventing the work efficiency from being decreased.

### Second Embodiment

The second embodiment shows a configuration in which skills are evaluated for each body part of an evaluation target worker.

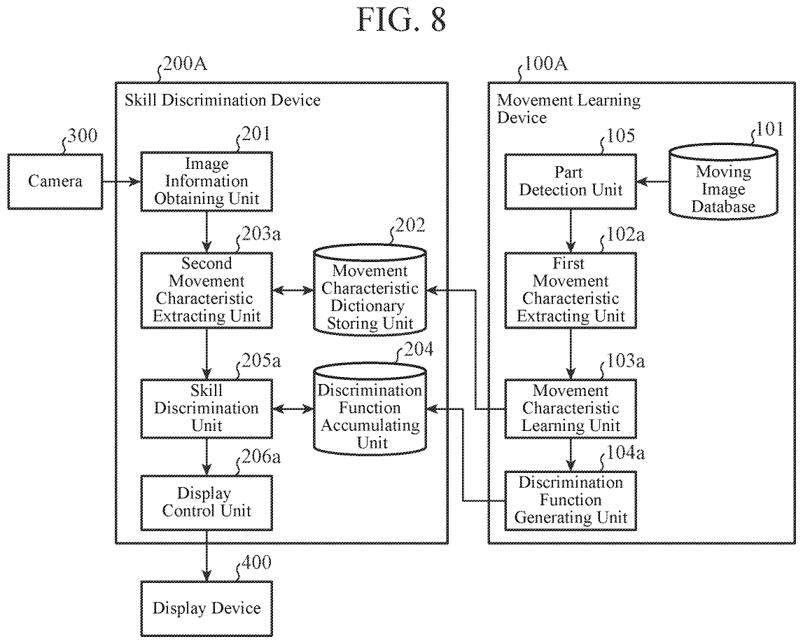

FIG. 8 is a block diagram illustrating a configuration of a skill discriminating system according to the second embodiment.

A movement learning device 100A of the skill discriminating system according to the second embodiment is configured by adding a part detecting unit 105 to the movement learning device 100 according to the first embodiment shown in FIG. 1. In addition, the movement learning device 100A is configured by being provided with a first movement characteristic extracting unit 102a, a movement characteristic learning unit 103a, and a discrimination function generating unit 104a in place of the first movement characteristic extracting unit 102, the movement characteristic learning unit 103, and the discrimination function generating unit 104.

A skill discriminating device 200A of the skill discriminating system according to the second embodiment is configured by being provided with a second movement characteristic extracting unit 203a, a skill discriminating unit 205a, and a display control unit 206a in place of the second movement characteristic extracting unit 203, the skill discriminating unit 205 and the display control unit 206 according to the first embodiment shown in FIG. 1.

Hereinafter, components that are identical to, or correspond to, components of the movement learning device 100 and the skill discriminating device 200 according to the first embodiment are denoted by reference numerals that are identical to those used in the first embodiment, and the explanation thereof will be omitted or simplified.

The part detecting unit 105 analyzes moving image data stored in the moving image database 101, and detects parts (hereinafter referred to as “parts of a worker”) of a skilled worker and an ordinary worker included in the moving image data. Here, parts of a worker are fingers, palms, wrists and the like of the worker. The part detecting unit 105 outputs information indicating the detected parts, and the moving image data to the first movement characteristic extracting unit 102a. The first movement characteristic extracting unit 102a extracts, from the moving image data, locus characteristics of movement of the skilled worker and the ordinary worker for each of the parts detected by the part detecting unit 105. The first movement characteristic extracting unit 102a outputs the extracted locus characteristics of movement to the movement characteristic learning unit 103a while associating the locus characteristics with information indicating corresponding parts of the worker.

The movement characteristic learning unit 103a determines, on a part basis, reference locus characteristics of movement from the locus characteristics of movement extracted by the first movement characteristic extracting unit 102a. The movement characteristic learning unit 103a performs, on a part basis, discrimination learning for identifying locus characteristics of skilled movement on the basis of the reference locus characteristics of movement. The movement characteristic learning unit 103a generates a movement characteristic dictionary that stores the determined reference locus characteristics of movement on a part basis, and stores the movement characteristic dictionary in the movement characteristic dictionary storing unit 202 of the skill discriminating device 200A. In addition, the movement characteristic learning unit 103a outputs the result of discrimination learning performed on a part basis to the discrimination function generating unit 104a. The discrimination function generating unit 104a refers to the result of learning by the movement characteristic learning unit 103a, and generates a discrimination function on a part basis. The discrimination function generating unit 104a accumulates the generated discrimination function in the discrimination function accumulating unit 204 of the skill discriminating device 200A.

The second movement characteristic extracting unit 203a refers to the movement characteristic dictionary stored in the movement characteristic dictionary storing unit 202, and extracts the locus characteristics of movement from the evaluation-target moving image data obtained by the image information obtaining unit 201. The second movement characteristic extracting unit 203a outputs the extracted locus characteristics of movement to the skill discriminating unit 205a while associating the locus characteristics with information indicating corresponding parts of the worker. The skill discriminating unit 205a uses the discrimination functions accumulated in the discrimination function accumulating unit 204 to discriminate, from the locus characteristics of movement extracted by the second movement characteristic extracting unit 203a, whether or not skills of an evaluation target worker are proficient. The skill discriminating unit 205a performs discrimination for each part that is associated with the locus characteristics of movement. The skill discriminating unit 205a outputs the discrimination results to the display control unit 206a while associating the discrimination results with information indicating corresponding parts of the worker. In accordance with the discrimination results from the skill discriminating unit 205a, the display control unit 206a determines, on a worker's part basis, information to be displayed as support information for the evaluation target worker.

Next, hardware configurations of the movement learning device 100A and the skill discriminating device 200A will be described as examples. It should be noted that the explanation of configurations identical to those of the first embodiment will be omitted.

The part detecting unit 105, the first movement characteristic extracting unit 102a, the movement characteristic learning unit 103a, and the discrimination function generating unit 104a in the movement learning device 100A correspond to the processing circuit 100a shown in FIG. 2A, or the processor 100b that executes a program stored in the memory 100c shown in FIG. 2B.

The second movement characteristic extracting unit 203a, the skill discriminating unit 205a, and the display control unit 206a in the skill discriminating device 200A correspond to the processing circuit 200a shown in FIG. 3A, or the processor 200b that executes a program stored in the memory 200c shown in FIG. 3B.

Next, the operation of the movement learning device 100A and the operation of the skill discriminating device 200A will be described. First of all, the operation of the movement learning device 100A will be described.

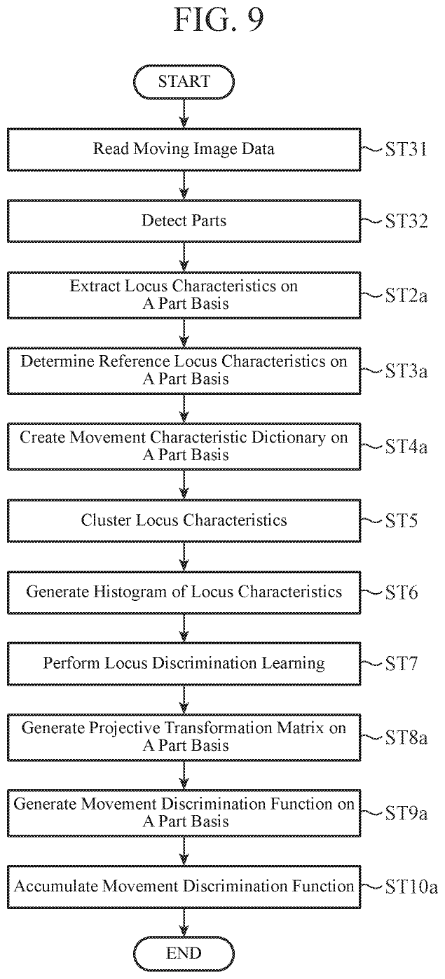

FIG. 9 is a flowchart illustrating the operation of the movement learning device 100A according to the second embodiment. It should be noted that in the flowchart shown in FIG. 9, steps identical to those in the flowchart of the first embodiment shown in FIG. 4 are denoted by identical reference numerals, and the explanation thereof will be omitted.

The part detecting unit 105 reads, from the moving image database 101, moving image data obtained by capturing images of movements of skilled workers and ordinary workers (step ST31). The part detecting unit 105 detects parts of a worker included in the moving image data read in the step ST31 (step ST32). The part detecting unit 105 outputs information indicating the detected parts, and the read moving image data to the first movement characteristic extracting unit 102a. The first movement characteristic extracting unit 102a extracts, from the moving image data read in the step ST31, locus characteristics of movement for each of the worker's parts detected in the step ST32 (step ST2a). The first movement characteristic extracting unit 102a outputs the locus characteristics of movement extracted on a worker's part basis to the movement characteristic learning unit 103a.

The movement characteristic learning unit 103a determines a plurality of reference locus characteristics on a worker's part basis (step ST3a). By using the plurality of reference locus characteristics determined in the step ST3a, the movement characteristic learning unit 103a creates a movement characteristic dictionary on a worker's part basis, and stores the movement characteristic dictionaries in the movement characteristic dictionary storing unit 202 of the skill discriminating device 200A (step ST4a). The movement characteristic learning unit 103a executes processes of steps ST5 to ST7 to generate a projective transformation matrix on a worker's part basis (step ST8a). The discrimination function generating unit 104a generates a discrimination function on a worker's part basis (step ST9a). The discrimination function generating unit 104a accumulates the generated discrimination functions in the discrimination function accumulating unit 204 of the skill discriminating device 200A while associating the discrimination functions with the corresponding worker's parts (step ST10a), and the processing ends.

Next, the operation of the skill discriminating device 200A will be described.

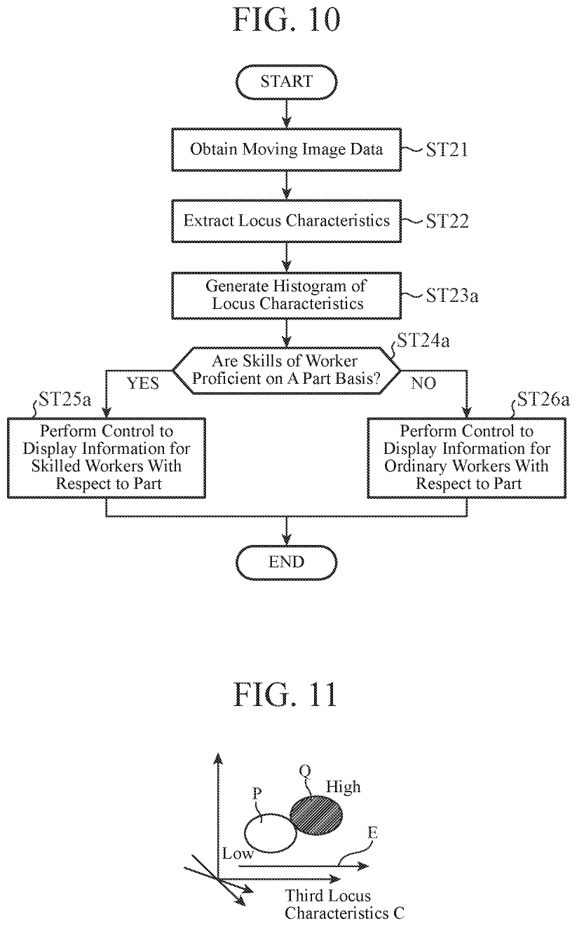

FIG. 10 is a flowchart illustrating the operation of the skill discriminating device 200A according to the second embodiment. It should be noted that in the flowchart shown in FIG. 10, steps identical to those in the flowchart of the first embodiment shown in FIG. 5 are denoted by identical reference numerals, and the explanation thereof will be omitted.

The second movement characteristic extracting unit 203a refers to the movement characteristic dictionaries stored in the movement characteristic dictionary storing unit 202, clusters the extracted locus characteristics, and generates a histogram corresponding to the frequencies of occurrence on a part basis (step ST23a). The second movement characteristic extracting unit 203a outputs the histograms generated in the step ST23a to the skill discriminating unit 205a while associating the histograms with the corresponding worker's parts. By using the discrimination function accumulated on a part basis in the discrimination function accumulating unit 204, the skill discriminating unit 205a discriminates, from the histograms generated in the step ST23a, whether or not skills are proficient on a worker's part basis (step ST24a). In the step ST24a, when skills of all parts have been discriminated, the skill discriminating unit 205a outputs the discrimination results to the display control unit 206a.

In a case where skills of a certain part of a worker in a working state are proficient (step ST24a; YES), the display control unit 206a performs the display control of the display device 400 so as to display information for workers whose skills are proficient with respect to the part (step ST25a). Meanwhile, in a case where skills of the certain part of the worker in a working state are not proficient (step ST24a; NO), the display control unit 206a performs the display control of the display device 400 so as to display information for ordinary workers (step ST26a). Subsequently, the processing ends. It should be noted that in a case where the discrimination results from the skill discriminating unit 205a indicate that although skills of a certain part are proficient, skills of another certain part are not proficient, the display control unit 206a performs both processes of the step ST25a and the step ST26a.

As described above, according to the second embodiment, the part detecting unit 105 that detects imaged parts of the skilled worker and the ordinary worker from the moving image data is provided, the first movement characteristic extracting unit 102a extracts locus characteristics on a detected part basis, the movement characteristic learning unit 103a generates, on a part basis, a histogram on a detected part basis to perform discrimination learning, and the discrimination function generating unit 104a generates a discrimination function on a detected part basis. Therefore, movement characteristics can be learned on a worker's part basis.

In addition, in the skill discriminating device 200A, information can be presented to an evaluation target worker on a part basis, and therefore information can be presented in detail.

The explanation above describes the configuration in which when the movement characteristic learning unit 103 or 103a performs two-class classification into a skilled worker group and an ordinary worker group in the discrimination analysis, a projection axis is calculated in such a manner that inter-class dispersion becomes maximum, and at the same time intra-class dispersion becomes minimum, and a discrimination boundary is determined. When a projection axis is calculated by adding a sparse regularization term, an element whose influence degree is low, is learned as weight “0”. This enables to have a configuration in which when the movement characteristic learning unit 103 or 103a calculates a projection axis, a projection axis is calculated by adding a sparse regularization term in such a manner that components of the axis include a large number of “0”.

The movement characteristic learning unit 103 or 103a calculates a projection axis by adding a sparse regularization term. As the result, it is possible to prevent a characteristic locus required to determine a discrimination boundary from becoming extraction of complicated characteristic loci, in other words, a combination of a plurality of loci. Therefore, the movement characteristic learning unit 103 is capable of determining a discrimination boundary by calculating a projection axis from a combination of fewer kinds of characteristics loci, from among a plurality of characteristic loci. This enables the skill discriminating device 200 or 200A to implement the presentation of a skill level which workers can easily understand.

FIG. 11 is a drawing illustrating effects produced in a case where a sparse regularization term is added in the movement learning device 100 according to the first embodiment.

FIG. 11 shows a work space and a locus E that are obtained when a projection axis is calculated by adding a sparse regularization term to the learning result shown in FIG. 6C in the first embodiment. The horizontal axis shown in FIG. 11D indicates the third locus characteristics C, and each of the other axes represents the frequency of occurrence of corresponding locus characteristics. The locus E is parallel to the third locus characteristics C, and displays, in a more understandable manner, a locus that presents skilled movement to workers.

Besides the above, a free combination of embodiments, a modification of any component of each embodiment, or an omission of any component of each embodiment can be made in the present invention within the scope of the invention.

### INDUSTRIAL APPLICABILITY

The movement learning device according to the present invention is capable of learning skilled movements of workers, and therefore is suitable for implementing the transfer of skills of skilled workers, by applying the movement learning device to a system or the like for supporting workers so as to show characteristics of movements of the skilled workers to the workers.

### REFERENCE SIGNS LIST

100, 100A Movement learning device
101 Moving image database
102, 102a First movement characteristic extracting unit
103, 103a Movement characteristic learning unit
104, 104a Discrimination function generating unit
105 Part detecting unit
200, 200A Skill discriminating device
201 Image information obtaining unit
202 Movement characteristic dictionary storing unit
203, 203a Second movement characteristic extracting unit
204 Discrimination function accumulating unit
205, 205a Skill discriminating unit
206, 206a Display control unit

1. A movement learning device comprising:
a processor to execute a program; and
a memory to store the program which, when executed by the processor, performs processes of,
extracting locus characteristics of movement of skilled workers and ordinary workers, on a basis of moving image data obtained by capturing images of the skilled workers and the ordinary workers;
clustering the locus characteristics that are similar to reference locus characteristics determined from among the locus characteristics extracted, generating at least one histogram on a basis of frequencies of occurrence of the clustered locus characteristics, and performing discrimination learning for identifying locus characteristics of skilled movement on a basis of the generated histogram;
referring to a result of the discrimination learning, and generating a discrimination function indicating a boundary for discriminating between skilled and unskilled movements; and
detecting imaged parts of the skilled workers and the ordinary workers from the moving image data, wherein the processes include
extracting locus characteristics for each of the detected parts,
generating the histogram and performing the discrimination learning, for each of the parts detected, and
generating the discrimination function for each of the detected parts.

2. The movement learning device according to claim 1, wherein
the processes include using a histogram of a group of the skilled workers and a histogram of a group of the ordinary workers, calculating a projection axis along which dispersion between the group of the skilled workers and the group of the ordinary workers becomes maximum and dispersion in each of the groups becomes minimum, and generating the discrimination function.

3. The movement learning device according to claim 1, wherein
the processes include performing the discrimination learning by using a discriminator based on machine learning.

4. (canceled)

5. The movement learning device according to claim 3, wherein
the processes include adding a sparse regularization term, and performing the discrimination learning by using the discriminator.

6. A skill discriminating device comprising:
a processor to execute a program; and a memory to store the program which, when executed by the processor, performs processes of,
extracting, from moving image data obtained by capturing an image of work of an evaluation target worker, locus characteristics of movement of the evaluation target worker, clustering the extracted locus characteristics of the evaluation target worker by using reference locus characteristics determined beforehand, and generating a histogram for each of parts of the evaluation target worker on a basis of frequencies of occurrence of the clustered locus characteristics;
discriminating, from the histogram generated whether or not movement for each of the parts of the evaluation target worker is proficient, by using a discrimination function for discriminating skilled movement for each of the parts of the worker, the discrimination function being predetermined for each of the parts by the movement learning device according to claim 1; and
performing control to display information for a skilled worker in a case where the movement of the evaluation target worker is proficient, and performing control to display information for an ordinary worker in a case where the movement of the evaluation target worker is not proficient, on a basis of a result of the discrimination.

7. A skill discriminating system comprising:
a processor to execute a program; and
a memory to store the program which, when executed by the processor, performs processes of,
extracting first locus characteristics of movement of skilled workers and ordinary workers, on a basis of moving image data obtained by capturing images of the skilled workers and the ordinary workers;
determining reference locus characteristics from among the first locus characteristics extracted, clustering the first locus characteristics similar to the determined reference locus characteristics, generating at least one histogram on a basis of frequencies of occurrence of the clustered first locus characteristics, and on a basis of the histogram, performing discrimination learning for identifying locus characteristics of skilled movement;
referring to a result of the discrimination learning, and generating a discrimination function indicating a boundary for discriminating between skilled and unskilled movements;
extracting, from moving image data obtained by capturing an image of work of an evaluation target worker, second locus characteristics of movement of the evaluation target worker, clustering the second locus characteristics by using the reference locus characteristics determined, and generating a histogram on a basis of frequencies of occurrence of the clustered second locus characteristics;
discriminating, from the histogram generated, whether or not movement of the worker in a working state is proficient, by using the discrimination function generated;
performing control to display information for a skilled worker in a case where the movement of the worker in a working state is proficient, and performing control to display information for an ordinary worker in a case where the movement of the worker in a working state is not proficient, on a basis of a result of the discrimination; and
detecting imaged parts of the skilled workers and the ordinary workers from the moving image data, wherein the processes include
extracting locus characteristics for each of the detected parts,
generating the histogram and performing the discrimination learning, for each of the parts detected, and
generating the discrimination function for each of the detected parts.
